(19) United States
(12) Patent Application Publication
(10) Pub. No.: US 2014/0014703 A1
(43) Pub. Date: Jan. 16, 2014

(54) FASTENER DRIVING TOOL WITH FASTENER DRIVING AND ROTATING MECHANISM

(71) Applicants: Kyle Kestner, Schaumburg, IL (US); Tomasz Sikora, River Grove, IL (US); Michael S. Popovich, Bartlett, IL (US)

(72) Inventors: Kyle Kestner, Schaumburg, IL (US); Tomasz Sikora, River Grove, IL (US); Michael S. Popovich, Bartlett, IL (US)

(73) Assignee: ILLINOIS TOOL WORKS INC., Glenview, IL (US)

(21) Appl. No.: 13/545,440

(22) Filed: Jul. 10, 2012

(51) Int. Cl. B25C 1/18; B25C 1/00; B25C 1/14

(52) U.S. Cl. 227/8; 227/9; 227/10

(57) ABSTRACT

A fastener-driving tool including a combustion power source configured for powering a driver blade drive system for reciprocal movement of a driver blade relative to a workpiece. The driver blade drive system includes a first portion configured such that the combustion power source linearly drives a driver blade towards the workpiece, and a second portion configured such that the driver blade is rotated relative to the workpiece.

### BACKGROUND

The present invention relates generally to fastener-driving tools used to drive fasteners into workpieces. More specifically, the invention relates to combustion-powered fastener-driving tools, also referred to as combustion tools or combustion nailers designed for axially driving as well as rotating fasteners.

Combustion-powered tools are known in the art. Representative tools are manufactured by Illinois Tool Works, Inc. of Glenview, Ill. for use in driving fasteners into workpieces, and are described in patents U.S. Pat. Re. No. 32,452, and U.S. Pat. Nos. 4,522,162; 4,483,473; 4,483,474; 4,403,722; 5,133,329; 5,197,646; 5,263,439; 6,145,724; and 7,588,096 all of which are incorporated by reference herein.

Such tools incorporate a tool housing enclosing a small internal combustion engine or power source. The engine is powered by a canister of pressurized fuel gas, also called a fuel cell. A battery-powered electronic power distribution unit produces a combustion within the chamber, while facilitating processes ancillary to the combustion operation of the device. Such ancillary processes include: mixing the fuel and air within the chamber, turbulence to increase the combustion process, scavenging combustion by-products with fresh air, and cooling the engine. The engine includes a reciprocating piston with an elongated, rigid driver blade disposed within a cylinder body.

A valve sleeve is axially reciprocable about the cylinder and, through a linkage, moves to close the combustion chamber when a work contact element at the end of the linkage is pressed against a workpiece. This pressing action also triggers a fuel-metering valve to introduce a specified volume of fuel into the closed combustion chamber.

Upon the pulling of a trigger switch, which causes the spark to ignite a charge of gas in the combustion chamber of the engine, the combined piston and driver blade is forced downward to impact a positioned fastener and drive the fastener into the workpiece. The piston then returns to its original or pre-firing position, through differential gas pressures within the cylinder. Fasteners are fed magazine-style into the nosepiece, where they are held in a properly positioned orientation for receiving the impact of the driver blade. Upon ignition of the combustible fuel/air mixture, the combustion in the chamber causes the acceleration of the piston/driver blade assembly and the penetration of the fastener into the workpiece if the fastener is present.

Such tools are typically employed with nails, brads, or similar fasteners designed for being axially or linearly driven into a workpiece. While these tools have been widely accepted for use in rough framing as well as finish construction, in the case of fastening metal frame members to each other, conventional fasteners installed by fastener driving tools have been found to lack sufficient holding power. In other applications, such fasteners have been difficult to extract if driven into an unwanted location. A fastener designed to address this problem is disclosed in US Patent Publication No. US 2009/0320328 which is incorporated by reference herein.

One installation factor when attaching metal to metal is the holding power of a single fastener. Traditionally, the fastener attaches the two layers of relatively thin metal, an application that does not provide adequate gripping surface for most fasteners. A challenge for fastener designers is to provide a fastener that is drivable using a power tool, but also satisfactorily holds together the two metal pieces.

U.S. Pat. No. 5,862,724 discloses a pneumatic fastener-driving tool having both linear and rotational fastener driving functions. One drawback of this tool is that, being pneumatically powered, the tool requires a remote compressor connected to the tool with a pressure hose. Such hoses are bulky and awkward to work around in many workplaces, and compressors are noisy and awkward to move around the jobsite.

U.S. Pat. No. 7,588,096 discloses a cordless fastener tool with fastener driving and rotating functions. A combustion power source drives a driver blade towards a workpiece, and an electrical power source provides power to rotate the driver blade. Both power sources are both housed in the tool. The electrical power source—used for rotating the drive blade—needs to be recharged from time to time. A sensor is required for detecting when to activate the electrical power source.

Thus, there is a need for a fastener-driving tool that addresses the above-identified drawbacks of conventional tools.

### SUMMARY

The above-identified needs are met or exceeded by the present fastener-driving tool that overcomes the limitations of the current technology. In the present tool, a single power source drives a driver blade assembly and a piston assembly towards a workpiece in two stages of operation, a first axial stage, and later, a second rotational stage that rotates the fastener in the workpiece for added fastening power. Transition between the stages is totally automatic and mechanically activated.

Preferably, in the first stage, the driver blade assembly and the piston assembly are driven together linearly towards a workpiece. Next, in the second stage, only the piston assembly moves linearly relative to the driver blade assembly, but the driver blade assembly rotates axially relative to the workpiece. As a result, the present tool features the ability to drive a fastener through two layers of thin, rigid material, such as metal, and to more positively retain the layers together.

More specifically, a fastener-driving tool is provided including a combustion power source configured for powering a driver blade drive system for reciprocal movement of a driver blade relative to a workpiece, the driver blade drive system including a first portion configured such that the combustion power source linearly drives a driver blade towards the workpiece, and a second portion configured such that the driver blade is rotated relative to the workpiece.

In another embodiment, a fastener-driving tool includes a housing, a cylinder disposed in the housing, the cylinder having a first end and a second end; a piston reciprocating within the cylinder; a driver blade connected to the piston and configured for linear movement towards a workpiece, the driver blade initially positioned adjacent to the first end of the cylinder and initially locked to restrict linear and rotational movement of the driver blade relative to the piston; and a power source disposed in the housing and configured for powering a piston assembly, the piston assembly configured for linearly driving the driver blade from the first end towards the second end, and configured for rotationally driving the driver blade relative to the workpiece.

In a further embodiment, a fastener-driving tool includes a piston assembly having a piston head and a piston sleeve attached to the piston head; and a driver blade assembly partially housed by the piston sleeve and configured to be linearly driven by the piston head. A helix apparatus is associated with the blade and the driver blade assembly. The driver blade assembly includes a driver blade that is moveable linearly and, through the helix apparatus, rotationally relative to the piston sleeve within the piston sleeve.

### BRIEF DESCRIPTION OF THE DRAWINGS

FIG. 1 is a perspective view of the present fastener-driving tool;

FIG. 2 is an assembled perspective view of the present piston assembly and the driver blade assembly;

FIG. 3 is an exploded view of the piston assembly and driver blade assembly of FIG. 2;

FIG. 4A is a fragmentary vertical cross-section of the present tool in an initial state;

FIG. 4B is a fragmentary vertical cross-section of the present tool before the driver blade assembly is unlocked;

FIG. 4C is a fragmentary vertical cross-section of the present tool after the driver blade assembly is unlocked;

FIG. 4D is a fragmentary vertical cross-section of the present tool once the driver blade assembly begins rotation;

FIG. 4E is a fragmentary vertical cross-section of the present tool at the end of the driving cycle;

FIG. 5 is a fragmentary perspective view of a wall under construction using metal framing members; and

FIG. 6 is an enlarged fragmentary perspective view of FIG. 6 showing the type of fastener used with, and applied by the present tool.

### DETAILED DESCRIPTION

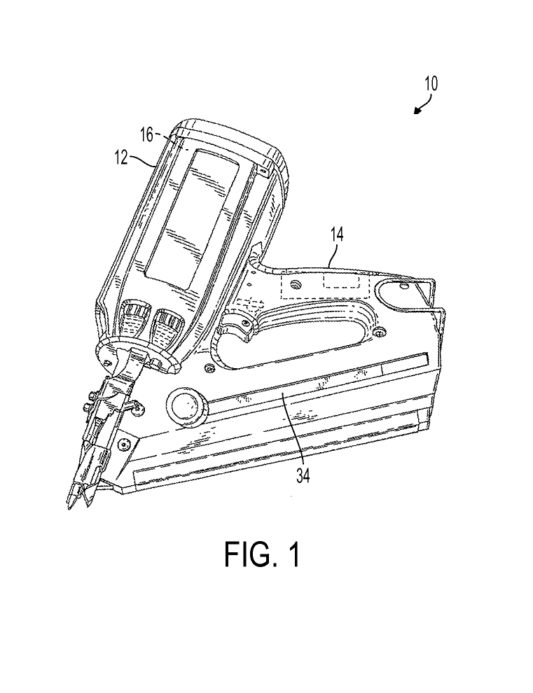

Referring to FIG. 1, a fastener-driving tool incorporating the present invention is generally designated 10 and preferably is of the general type described in detail in the patents listed above and incorporated by reference in the present application. While in the preferred embodiment, the tool 10 is a combustion tool, it is contemplated that the present system for driving and rotating the driver blade can be incorporated into other powered tools, including but not limited to pneumatic and electrically powered tools. The tool 10 includes a housing 12 and a rearwardly extending handle 14. Other components of the tool 10 are well known in the art, including the patents incorporated by reference, and need not be discussed in the context of the present drive system.

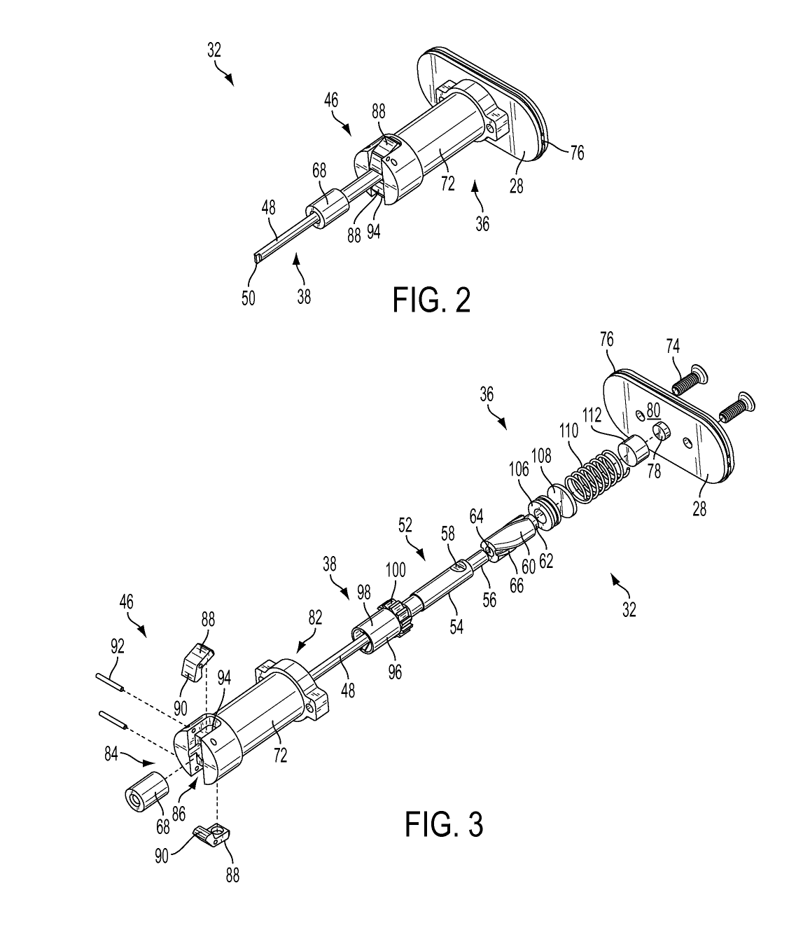

Turning to FIGS. 2-4A, a combustion power source 16 at least partially disposed in the tool housing 12 includes a cylinder head 18 supporting an electrically powered fan 20 and a spark plug 22 as is known in the art. As is well known in the art, combustion power is generated when a mixture of fuel and air injected into the combustion chamber 24 is stirred by the fan 20 and ignited by the spark plug 22. The cylinder head 18 forms an upper end of a combustion chamber 24, which is also defined by a reciprocating valve sleeve 26 and an upper end of a piston 28. The piston 28 reciprocates in a cylinder 30 depending from the combustion chamber and secured relative to the housing 12. A driver blade drive system 32 is disposed in the cylinder 30 for reciprocal linear movement in driving fasteners sequentially supplied by a tool magazine 34 (FIG. 1).

As best shown in FIGS. 2 and 3, the driver blade drive system 32 includes two main components: a piston assembly 36 and a driver blade assembly 38. The horizontal cross-sectional shape of a channel 40 defined by the cylinder 30, and also the shape of the piston 28 is preferably such that the piston assembly 36 cannot rotate relative to the cylinder. In the preferred embodiment, the cross-sectional shape is oval, however other shapes are contemplated.

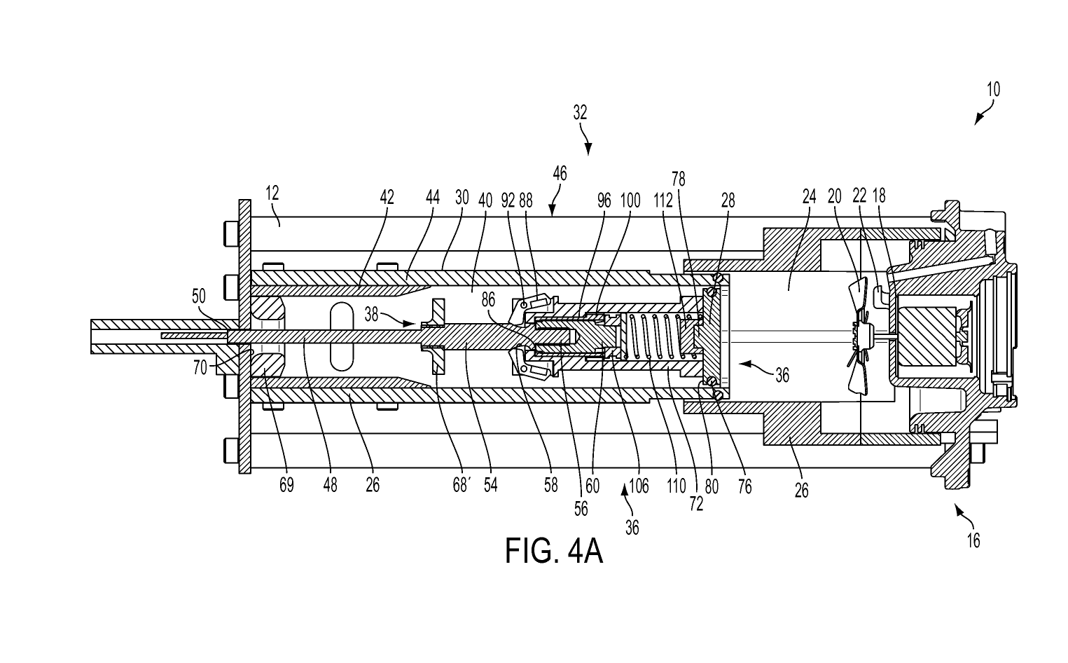

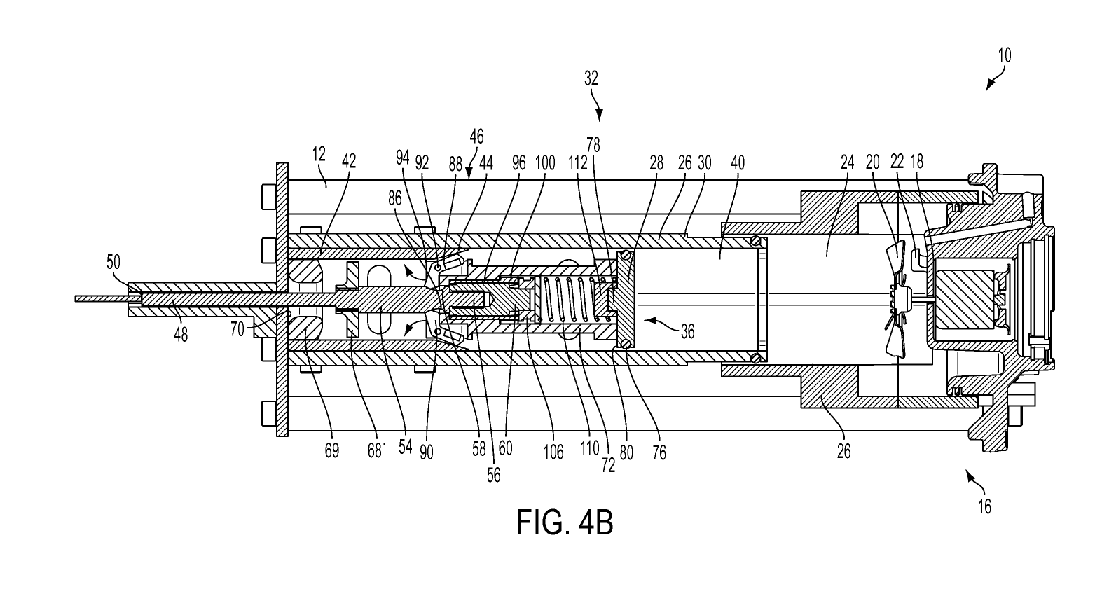

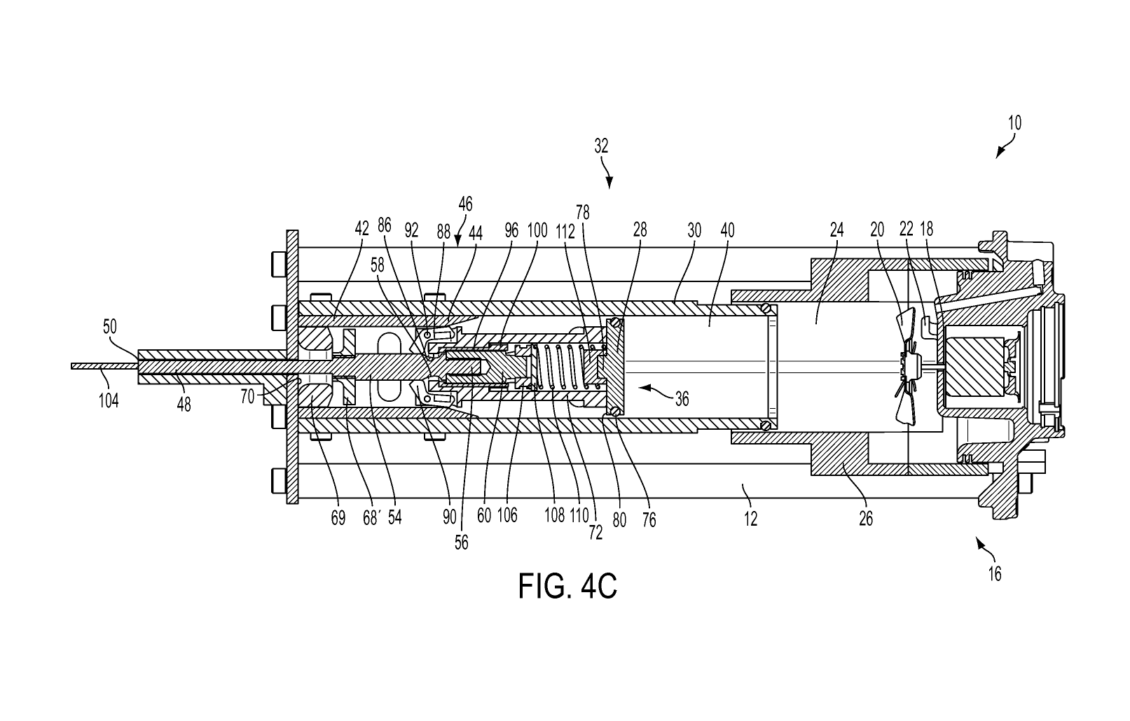

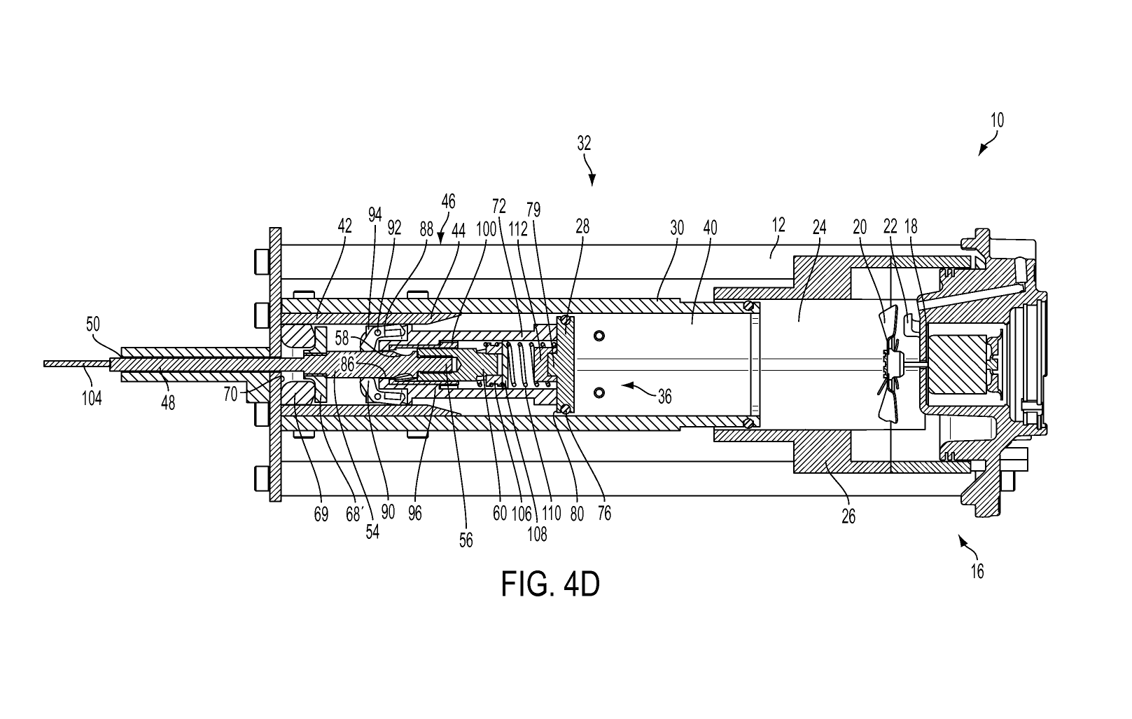

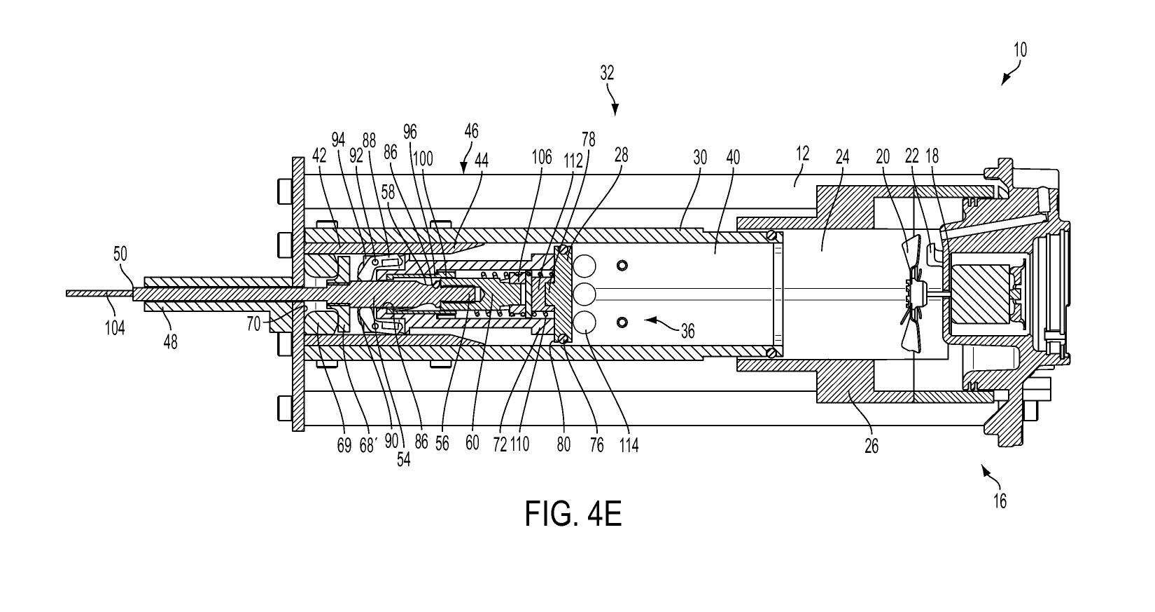

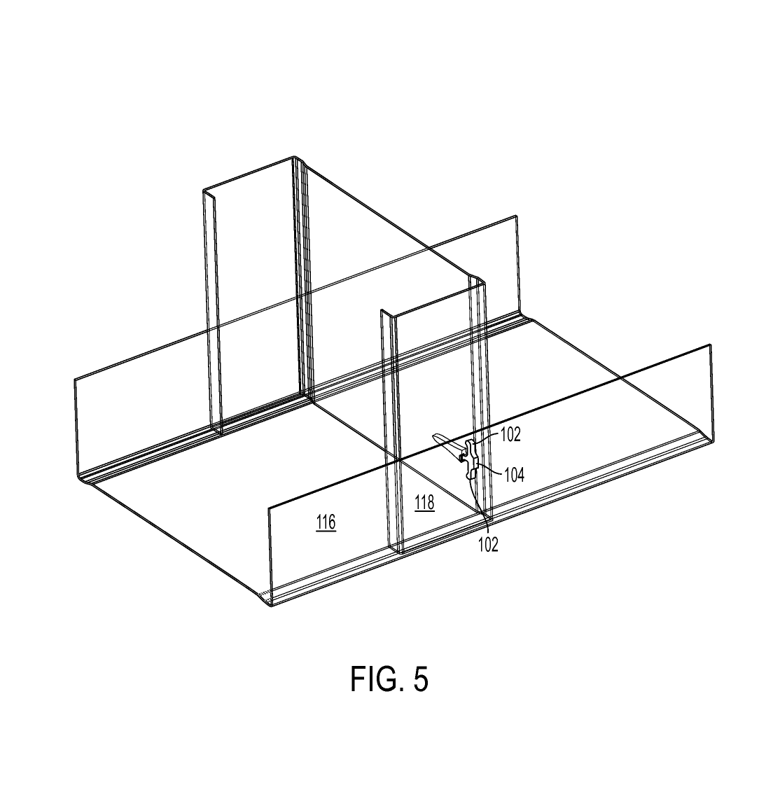

An unlocking element 42 is formed on a portion of the inside surface of the cylinder 30. As shown in FIG. 4A, the unlocking element 42 defines a reduced diameter of the channel 40, and is embodied as an insert in the cylinder 30 having a first, tapered end 44 is defining a incline so that an inside surface of the cylinder 30 and the first end 44 meet at an obtuse angle, which provides for a smooth engagement between the unlocking element 42 and a locking mechanism 46. The unlocking element 42 is configured to disengage the locking mechanism 46, as will be described later. Alternatively, the unlocking element 42 can be formed as separate, circumferentially-spaced pieces that correspond to the radial configuration of the locking mechanism 46.

Now referring to FIGS. 2 and 3, the driver blade assembly 38 includes an elongated, rigid driver blade 48 to which several functional components are added as individual components or, alternately formed integrally. More specifically, the driver blade 48 has a working end 50 configured for engaging a fastener, having a slotted, Phillips, hex, TORX® head or interchangeable bit fitting configuration, as is well known in the fastener driving art. An opposite piston end 52 includes a relatively larger diameter driver blade head 54 having a boss 56 at one end and defining at least one notch 58. In a preferred embodiment, the driver blade head 56 has two, preferably concave notches 58, diametrically opposite of one another, however the number, shape and position of the notches varies depending on the application. The purpose of the notches 58 will be described later.

The piston end 52 of the driver blade assembly 38 preferably includes a helix 60. The preferably cylindrical helix 60 has a helix boss 62 at a first end, an opposite end counterbore 64 for matingly engaging the boss 56, and at least one helical groove 66 formed along its surface and extending in a generally axial direction. In the preferred embodiment, the helix 60 is press-fit upon the driver blade head 54 to form a friction fit, however it is also contemplated that the driver blade 48, the head, and the helix are unitarily formed.

In the preferred embodiment, a hollow-cylindrical bumper 68 is disposed on the driver blade 48 near the driver blade head 54. An internal diameter of the hollow bumper 68 is slightly larger than the diameter of the driver blade 48, but smaller than that of the driver blade head 54. As is known in the art, the bumper 68 is constructed of a material such as plastic or rubber designed for withstanding repetitive, high-impact compressive forces. In an alternative embodiment, the bumper 68 is replaced by a rigid, preferably metal disk 68′ secured to the driver blade 48 (FIGS. 4A-4E) and a second bumper 69 is disposed on a floor surface 70 of the cylinder 30 instead of the bumper 68 on the driver blade 48. The metal disk 68′ serves as a stop for the driver blade 48 once the metal disk impacts the bumper 69.

The piston assembly 36 includes a piston sleeve 72 and the piston 28, fastened together, preferably with fasteners 74 such as screws or the like. The piston 28 preferably has a seal 76 such as an 0-ring, creating a sliding seal between the cylinder 30 and the piston. As shown in FIGS. 3 and 4A, the piston 28 also has a nub 78 on an underside 80, as will be described below.

Referring now to FIGS. 2-4A, the piston sleeve 72 is hollow and has an open end 82 attached to the underside 80, and an opposite locking end 84. The locking end 84 has an aperture 86 sized to slidably accommodate the driver blade 48. Generally, a portion of the driver blade assembly 38 is housed inside the piston sleeve 72, including a portion of the driver blade head 54 and the helix 60.

The locking mechanism 46 is disposed towards the locking end 84 of the piston sleeve 72. In a preferred embodiment, the locking mechanism 46 is formed of metal or other material able to withstand repetitive, high-impact forces. The locking mechanism 46 includes at least one and preferably two locking tabs 88 that are each angled, bent or dog-leg shaped, with a free end 90 each engaging the notch 58 on the driver blade head 54, and the opposite end being pivotally engaged on the piston sleeve 72 with a locking clip pin 92. The locking tabs 88 are constrained to a certain range of motion, governed by the shape of the piston assembly 36 and the locking mechanism 46.

Preferably, the locking mechanism 46 is biased to a position of engagement with the notches 58 on the driver blade head 56. The bias can be achieved by, for example, a spring (not shown) or a weight (not shown). The bias can be overcome—and the locking mechanism 46 rotated and disengaged from the notch 58—by applying a force to the locking tabs 88, opposite the free ends 90.

When engaged in the notches 58 on the driver blade head 56, the driver blade 54 and the driver blade assembly 38 are prevented from moving relative to the piston assembly 36. The locking tabs 88 are sized to pivot within slots 94 in the piston sleeve 72, and in a release position, where the free ends 90 are released from the notches, the driver blade 54 and the driver blade assembly 38 can move relative to the piston assembly 36, both linearly and rotationally. As will be described below, this movement is achieved when the piston assembly 36 engages the unlocking element 42 during the fastener driving cycle.

Referring now to FIG. 3, an internal helix 96 is fixed in the hollow piston sleeve 74. Also tubular and hollow, the internal helix 96 includes a complementary, radially inwardly extending helix formation that matingly and slidingly engages the groove 66 on the helix 60. Thus, with the driver blade head 54 released from the piston assembly 36, engagement between the helix 60 and the internal helix 96 causes the driver blade to rotate about its longitudinal axis to provide a fastener rotating function. An outer surface 98 of the internal helix 96 is generally cylindrical, with fins 100 located at one end of exterior surface for frictional engagement with the piston sleeve 72 to prevent relative movement between the internal helix and the sleeve 74.

It is contemplated that the helix 60 and the internal helix 96 are optionally configured to reverse the male-female engagement.

Also, the helical formation (not shown) of the internal helix 96 is dimensioned to rotate the driver blade assembly 38 a predetermined amount. The amount of rotation ultimately depends on the number of points 102 on the fastener 104, and ideally follows the following equation:

$$Ideal Amount of Rotation = \frac{360 °}{2 * ( Number of Points )}$$

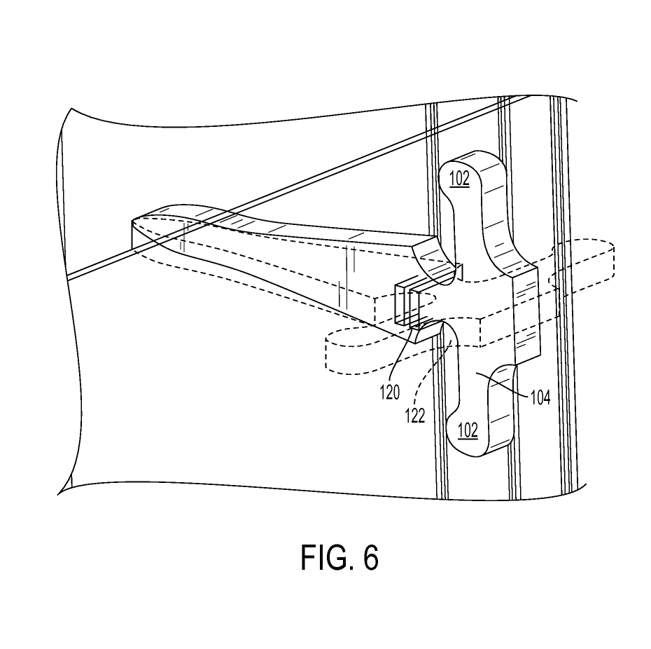

Referring to FIGS. 5 and 6, the fastener 104 has two points 102 so the ideal amount of rotation is 90°. If the fastener 104 had three points 102, then the ideal amount of rotation would be 60°. Since the piston assembly 36 is dimensioned so that it cannot rotate within the cylinder 30 and the internal helix 96 is fixed to the piston assembly 36, relative movement between the internal helix 96 and the helix 60 causes the driver blade assembly 38 to rotate relative to the piston assembly.

Referring back to FIGS. 3-4A, an optional disk-shaped, hollow center bearing 106 is optionally matingly and rotatably engaged on the helix boss 62 for facilitating aligned rotation of the driver blade assembly 38 relative to the piston assembly 36. On a side of the bearing 106 opposite the helix 60, a disk plate 108 forms a seat for one end of a biasing element 110, preferably a compression spring or the like. An opposite end of the spring 110 is located upon an alignment boss 112 which in turn is located upon the nub 78 on the underside 80 of the piston 28. As will be discussed below, the biasing element 110 facilitates return of the driver blade assembly 38 relative to the piston assembly 36 after the driver blade 54 completes the fastener driving cycle.

Referring now to FIGS. 4A-4E, the fastener-driving cycle of the present tool is depicted. In FIG. 4A, the rest position, the piston 28 is in a pre-firing position, and the locking tabs 88 engage the notches 58 so that the driver blade assembly 38 moves with the piston assembly 36. In other words, the driver blade system 32 moves as a unit.

In FIG. 4B, combustion has occurred in the combustion chamber 24, and the driver blade system 32 is driven down the channel 40 in the cylinder 30. Before the driver blade system 32 reaches the farthest point in its operational stroke, the locking tabs 88 engage the unlocking element 42, which causes pivoting action of the tabs about the pins 92 and releases the free ends 90 from the notches 58.

Referring now to FIG. 4C, it will be seen that the unlocking element 42 is dimensioned to accommodate relative axial movement of the piston sleeve 72 when the locking tabs 88 have been retracted by the unlocking element. The piston sleeve 72 continues its movement toward the fastener, and eventually the metal disk 68′ engages the second bumper 69, or alternatively the floor surface 70 of the cylinder 30, which essentially finishes the downward movement of the driver blade 38. Since the piston sleeve 72 has moved axially relative to the driver blade 54 after the release of the locking tabs 88, the interaction of the helix 60 with the internal helix 96 causes the driver blade to rotate about the longitudinal axis of the driver blade, exerting a rotating force upon a fastener 110 (FIG. 6).

Referring now to FIG. 4D, as the piston sleeve 72 continues to move towards the floor surface 70 and relative to the driver blade 54, it will be seen that the biasing element 110 is compressed between the piston 28 and the plate 108. Also, the locking tabs 88 are radiused at the free ends 90 to reduce friction as they slide axially relative to the driver blade 54.

In FIG. 4E, the driver blade assembly 38 has completed rotation relative to the piston assembly 36. The metal disk 68′ remains in contact with the second bumper 69, or alternatively the floor surface 70, preventing substantial linear movement of the driver blade assembly 38 towards the workpiece. However, due to the resilience of the bumper 69, some negligible movement is contemplated. Also, the steel disk plate 108 is in contact with the alignment boss 112, thereby preventing the piston assembly 36 from moving linearly any farther towards the workpiece. The linear relative displacement between the internal helix 96 and the helix 60 is at a maximum. Thus, the driver blade assembly 38 and the fastener 104 have completed rotation. However, a portion of the helix 60 still remains engaged with the internal helix 96, allowing the biasing element 110, acting as a supplemental power source, to push the helix 60 back to a starting position within the internal helix 96.

Also seen in FIG. 4E is the exposed, petal-valved ports 114 of the exhaust valve, through which the spent combustion gases exit the tool 10, as is well known in the art. Thus, at this point, as long as the valve sleeve 26 remains in position to seal the combustion chamber 24, there is a pressure differential on either side of the piston 28, which draws the piston back to the pre-firing position of FIG. 4A. Through the cooperative engagement of the helices 60, 96, the driver blade 54 is counter-rotated back to its original position. Since the piston sleeve 72 is moving relative to the driver blade assembly 38, such movement enhanced by the decompression of the biasing element 106, the locking tabs 88 move back up the driver blade 54 until the free ends 90 reengage the notches 58. At that point, as the piston sleeve 72 moves closer towards the fan 20, the driver blade assembly 38 is pulled away from the workpiece and moves towards the fan with the piston sleeve. Thus, the driver blade system 32 is returned to the pre-firing position of FIG. 4A for driving another fastener.

Referring now to FIGS. 5 and 6, a conventional interior construction site is shown, with a metal floor channel 116 having vertical metal studs 118 attached using the fasteners 104. As is known in the art, upon assembly of a frame including the studs 118 and the floor channel 116, wallboard panels (not shown) are attached to the frame. Through the linear driving action of the tool 10, a generally horizontal slot 120 has been formed in the metal components 116, 118. Since the fastener 104 has a rectangular narrowed neck 122, rotation of the fastener by the tool 10 as described above rotates the fastener approximately 90°. Due to the shape of the fastener neck 122, this rotation locks the fastener 104 in place, forming a more positive engagement between the fastener and metal frame components 116, 118.

While a particular embodiment of the present fastener tool with fastener driving and rotating functions has been described herein, it will be appreciated by those skilled in the art that changes and modifications may be made thereto without departing from the invention in its broader aspects and as set forth in the following claims.

1. A fastener-driving tool, comprising:
a combustion power source configured for powering a driver blade drive system for reciprocal movement of a driver blade relative to a workpiece, said driver blade drive system including a first portion configured such that said combustion power source linearly drives a driver blade towards the workpiece, and a second portion configured such that said driver blade is rotated relative to the workpiece.

2. The fastener-driving tool according to claim 1, wherein said driver blade drive system includes a piston sleeve;
a helix disposed on said driver blade; and
an internal helix fixed on said piston sleeve and configured for engaging said helix to rotate said driver blade relative to said piston sleeve.

3. The fastener-driving tool according to claim 2, wherein said first portion of said driver blade drive system is further configured to stop linear motion of said driver blade at a predetermined location relative to said workpiece; and
wherein said piston sleeve continues linear movement towards the workpiece in the second portion of said driver blade drive system, and said internal helix linearly moves relative to said helix, thereby rotating said driver blade.

4. The fastener-driving tool according to claim 1, further comprising:
a cylinder having a first end and a second end, and housing said driver blade;
said combustion power source driving said driver blade from said first end towards said second end;
a locking mechanism associated with said driver blade for restricting rotational movement of said driver blade with respect to the workpiece; and
an unlocking element disposed towards said second end of said cylinder and configured for disengaging said locking mechanism.

5. The fastener-driving tool according to claim 4, wherein said unlocking element disengages said locking mechanism as said driver blade is driven towards said second end of said cylinder, thereby allowing said driver blade to rotate relative to the workpiece.

6. The fastener-driving tool according to claim 4, further comprising a supplemental power source configured for engaging said unlocking element with said locking mechanism.

7. The fastener-driving tool according to claim 4, further comprising:
a piston assembly comprising a piston head and a piston sleeve disposed in said cylinder;
wherein said piston sleeve houses a portion of said driver blade.

8. The fastener-driving tool according to claim 7, wherein said piston sleeve is configured to allow linear and rotational movement of said driver blade relative to said piston sleeve.

9. The fastener-driving tool according to claim 7, wherein cross-sectional shape of said piston head is such that said piston head cannot rotate relative to said cylinder.

10. The fastener-driving tool according to claim 7, further comprising:
at least one notch formed on said driver blade;
wherein said locking mechanism is disposed on said piston sleeve and includes at least one movable prong configured to be biased to a position which engages said at least one notch, thereby preventing said driver blade from rotating relative to said piston sleeve.

11. The fastener-driving tool according to claim 10, wherein said unlocking element disengages said locking mechanism as said driver blade is driven towards said second end of said cylinder, and said at least one movable prong is disengaged from said at least one notch, thereby allowing said driver blade to rotate relative to said piston sleeve.

12. A fastener-driving tool, comprising:
a housing;
a cylinder disposed in said housing, said cylinder having a first end and a second end;
a piston reciprocating within said cylinder;
a driver blade connected to said piston and configured for linear movement towards a workpiece, said driver blade initially positioned adjacent to said first end of said cylinder and initially locked to restrict linear and rotational movement of said driver blade relative to said piston; and
a power source disposed at least partially in said housing and configured for powering a piston assembly, said piston assembly configured for linearly driving said driver blade from said first end towards said second end, and configured for rotationally driving said driver blade relative to the workpiece.

13. The fastener-driving tool according to claim 12, further comprising an unlocking element disposed on said cylinder towards said second end and configured for unlocking said driver blade to allow for rotational movement once said driver blade reaches a predetermined position.

14. The fastener-driving tool according to claim 12, further including a piston assembly configured for rotating said driver blade a predetermined amount,

15. A fastener-driving tool, comprising:
a piston assembly having a piston head and a piston sleeve attached to said piston head; and
a driver blade assembly partially housed by said piston sleeve and configured to be linearly driven by said piston head, and including a driver blade;
a helix apparatus associated with said driver blade and said driver blade assembly;
wherein said driver blade assembly includes a driver blade that is moveable linearly and, through said helix apparatus, rotationally relative to said piston sleeve.

16. The fastener-driving tool of claim 15, further comprising:
at least one notch formed on said driver blade; and
a locking mechanism rotatably attached to said piston sleeve and biased to engage said at least one notch to prevent linear and rotational movement between said driver blade and said piston sleeve.

17. The fastener-driving tool of claim 16, further comprising:
a cylinder which houses said piston and said driver blade assembly, said cylinder having a first end and a second end; and
an unlocking element disposed on said second end of said cylinder, said unlocking element configured for disengaging said locking mechanism from said at least one notch, thereby allowing linear and rotational movement between said driver blade assembly and said piston sleeve.

18. The fastener-driving tool of claim 17, further comprising:
said driver blade assembly comprising a driver blade having a piston end and a working end and said helix apparatus includes a helix disposed on said piston end of said driver blade; and
an internal helix attached to said piston sleeve, said internal helix configured to engage said helix, causing said driver blade assembly to rotate relative to said piston sleeve.

19. The fastener-driving tool of claim 18, wherein said unlocking element disengages said locking mechanism at a predetermined location on said cylinder.

20. The fastener-driving tool of claim 19, further comprising:
a housing containing said cylinder;
a combustion power source disposed in said housing and configured for reciprocating said piston from said first end of said cylinder towards said second end of said cylinder; and
a disk disposed on said driver blade assembly and configured for engaging a bumper in said cylinder, and impact of said disk upon said bumper configured for stopping linear movement of said driver blade assembly;
wherein said piston linearly moves relative to said driver blade assembly, and said internal helix moves linearly with respect to said helix, rotating the driver blade relative to the workpiece.
